(19) United States
(12) Patent Application Publication
(10) Pub. No.: US 2014/0183021 A1
(43) Pub. Date: Jul. 3, 2014

(54) FLOAT SWITCH DEVICE WITH MAGNETIC TONGUE

(71) Applicant: Yung-Chih TSAI, New Taipei City (TW)

(72) Inventor: Yung-Chih TSAI, New Taipei City (TW)

(21) Appl. No.: 13/729,601

(22) Filed: Dec. 28, 2012

(51) Int. Cl. H01H 35/18

(52) U.S. Cl. CPC H01H 35/18
USPC 200/84 C

(57) ABSTRACT

A float switch device includes a tubular member, a magnet tube and a magnetic switch. The tubular member has a first restriction portion and a second restriction portion formed on an external surface thereof. The magnet tube is sleeved over the tubular member, and is movable between the first restriction portion and the second restriction portion. The magnetic switch includes at least two metal tongues, where each of the metal tongues includes an interior contact point and an exterior contact point. The float switch device is placed in a casing in such way that the exterior contact points are electrically connected to an external apparatus. When the casing is tilted upward or downward by the change in water level, the magnet tube moves between the first and second restriction portions to switch the float switch device between the ON/OFF state.

### BACKGROUND OF THE INVENTION

1. Field of the Invention

The present invention relates to a float switch device, especially relates to a float switch device, which is actuated by a magnetic switch provided with a magnetic tongue.

2. The Prior Arts

A float switch device is usually used in a liquid storage tank to control the volume of the liquid in the tank. Since the specific weight of the entire float switch device is smaller than the specific weight of the liquid, the float switch device can float on the liquid. The interior components of the float switch device have different structure. However, they share the same principle, where a part of the interior components is actuated when the tilted angle of the float switch device is changed due to a change in the liquid level. The actuation of the interior components in the float switch device then turns an apparatus connected therewith “ON” or “OFF”.

Herein, a conventional float switch device is introduced. FIGS. 5A and 5B are the schematic views showing the internal structure of a conventional switch device 4. As shown in the Figures, a gourd-shaped recess is formed inside the main body 41, and a ball 42 is placed within the gourd-shaped recess. A box 45 with a button 44 is disposed below the main body 41, and a rod 43 is pivotally connected to the main body 41 adjacent to the button 44. In FIG. 5A, the float switch device is not yet floated on the liquid, so the ball 42 is located at the upper portion of the gourd-shaped recess. Once the float switch device is floated on the liquid, the ball 42 will press downward against the rod 43 due to gravity and further pushes the button 44, thereby turning “ON” the apparatus connected to the float switch device.

The conventional float switch device has a drawback of short lifespan, due to the plastic material used in the rod 43 and the heavy weight of the ball 42. In addition, the degree of freedom of the ball 42 is rather high, so it is hard to control the float witch device to be “ON” or “OFF” precisely. Furthermore, the conventional float switch device can only be used to turn “ON” the switch device when the latter is in a floated condition. In a circumstance, where the apparatus connected needs to be turned “OFF” when the float switch device is in a floated condition, the structure of interior components of the float switch device must be redesigned, hence resulting in undesired expenses for the manufacturers.

### SUMMARY OF THE INVENTION

The primary purpose of the present invention is to provide a stable float switch device to solve the abovementioned drawbacks of the conventional float switch device. In addition, the present invention utilizes a convenient design with contact points, which allows the float switch device to be applicable in more conditions.

The float switch device provided by the present invention is mainly actuated by the gravity and the magnets. The magnets disposed on a magnet tube attracts and changes the position of the interior contact point inside the magnetic tongue switch device, so the two metal tongues inside the magnetic tongue switch device can be electrically conducted to turn “ON” an external apparatus connected thereto. The position of the magnet tube described above will change according to the tilted angle of the float switch device, which is affected by the liquid level that the float switch device is in the floated state. In addition, the movement of the magnet tube is restricted by a first restriction portion and a second restriction portion, and the distance between the first and second restriction portion can be used to control the float switch to be “ON” or “OFF”. With the above described configuration, the drawbacks of the conventional switch device can be resolved.

The float switch device provided by the present invention includes: a tubular member, a magnet tube and a magnetic switch. The tubular member has a first restriction portion and a second restriction portion formed on the external surface thereof. The magnet tube is sleeved over the tubular member, and is movable between the first and second restriction portions. The magnetic switch includes at least two metal tongues, each having an interior contact point and an exterior contact point. The magnetic switch is placed inside the tubular member in such way that the exterior contact point is attracted by the magnet tube; also, the interior contact point of the metal tongue extends outward or is exposed outside the tubular member. Preferably, the first and second restriction portions are formed from magnetic materials.

The float switch device provided by the present invention is disposed inside a casing, and the exterior contact points thereof are electrically connected to an external apparatus. The types of apparatuses connected can be varied according to different applications of the present invention, which will be described in details later in the section of preferred embodiments.

Preferably, the metal tongues of the float switch device are a first metal tongue, a second metal tongue and a switching metal tongue. Each of the metal tongue has two opposite ends respectively defining the interior contact point and the exterior contact point, where the interior contact point of switching metal tongue is electrically in contact with the interior contact point of first metal tongue. When the magnet tube abuts the first restriction portion, the interior contact point of the switching metal tongue is then attracted to be electrically in contact with the interior contact point of second metal tongue.

The present invention can be used in a space or storage to control the volume of the liquid contained therein. The float switch device can float on the liquid, and as the level of the liquid changes, the structure of inner components of the float switch device can control the apparatus connected with the float switch device to be “ON” or “OFF”, thereby controlling the volume of the liquid.

### BRIEF DESCRIPTION OF THE DRAWINGS

FIG. 1A is an perspective and exploded view showing a float switch device of the present invention;

FIG. 1B is an enlarged view of a circled portion shown in FIG. 1A;

FIG. 2 is a perspective view showing the float switch device of the present invention;

FIG. 3 is a schematic view showing the float switch device of the present invention in use;

FIG. 4A is a partially sectional view showing the first embodiment of the float switch device of the present invention in use;

FIG. 4B is a partially sectional view showing the second embodiment of the float switch device of the present invention in use;

FIG. 5A is a plane schematic view showing the conventional float switch device when not in use; and

FIG. 5B is a plane schematic view showing the conventional float switch device in use.

### DETAILED DESCRIPTION OF THE PREFERRED EMBODIMENTS

The present invention will be apparent to those skilled in the art by reading the following detailed description of preferred embodiments thereof, with reference to the attached drawings.

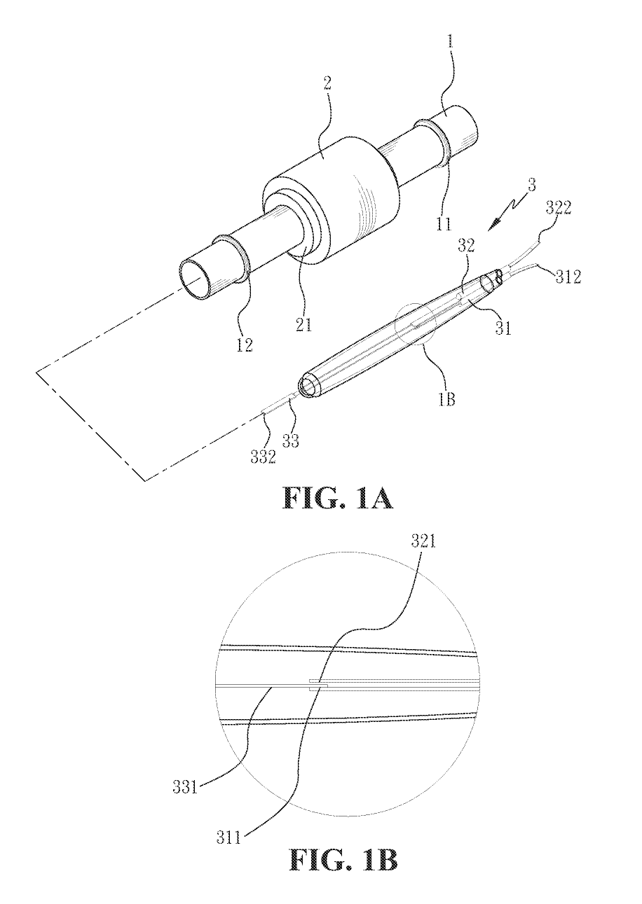

FIG. 1A is perspective and exploded view showing the float switch device of the present invention. As shown in FIG. 1A, the float switch device of the present invention includes a tubular member 1, a magnet tube 2 and a magnetic switch 3.

The tubular member 1 is a hollowed tube and is made from stainless steel. An iron ring is sleeved onto the tubular member 1 to form a first restriction portion 11 with a distance from an end of the tubular member 1. After the magnet tube 2 is sleeved over the tubular member 1, an another iron ring is disposed on the tubular member 1 so as to form a second restriction portion 12 with a certain distance from the other end of the tubular member 1, as best shown in FIG. 1A. Preferably, the first and second restriction portions 11 and 12 are made from magnetic materials. In addition, the first and second restriction portions 11 and 12 can be fixed onto the external surface of the tubular member 1 with adhesives, welding or retention grooves formed on the tubular member 1.

The magnet tube 2 is formed by a hollowed metal cylinder and two tubular magnets 21. The material for the hollowed metal cylinder should have a larger specific weight, so that the cylinder is heavier in weight even though it is small in size. The inner diameter of the cylinder is slightly larger than the outer diameter of the tubular member 1 while the tubular magnets 21 are respectively fixed to two opposite ends of the cylinder, thereby forming step-shaped structures or two shoulders respectively at opposite ends of the cylinder. Herein, the tubular magnets 21 are fixed to the cylinder by means of adhesives or simply with a tight-fit between the outer peripheries of the tubular magnets 21 and the inner peripheries of the opposite ends of the cylinder.

Preferably, the magnetic switch 3 is a commonly seen switch with three contact points. The main body of the magnetic switch is a glass tube which contains non-active gas inside. A first metal tongue 31 and a second metal tongue 32 are disposed at an end of the glass tube while a switching metal tongue 33 is disposed at the other end of the glass tube. The first metal tongue 31 and the second metal tongue 32 are made from magnetic materials and are configured in a way that they are spaced apart from each other with a certain distance. Each of the metal tongues includes an interior contact point 311, 321 and 331, and an exterior contact point 312, 322 and 332. In the present invention, the interior contact point 311 of the first metal tongue 31 is in contact with the interior contact point 331 of the switching metal tongue 33. In addition, the interior contact points 311, 321 and 331 of each metal tongues can be electroplated with expensive metals such as platinum, gold, rhodium (Rd) and ruthenium (Ru) to increase the conductivity thereof

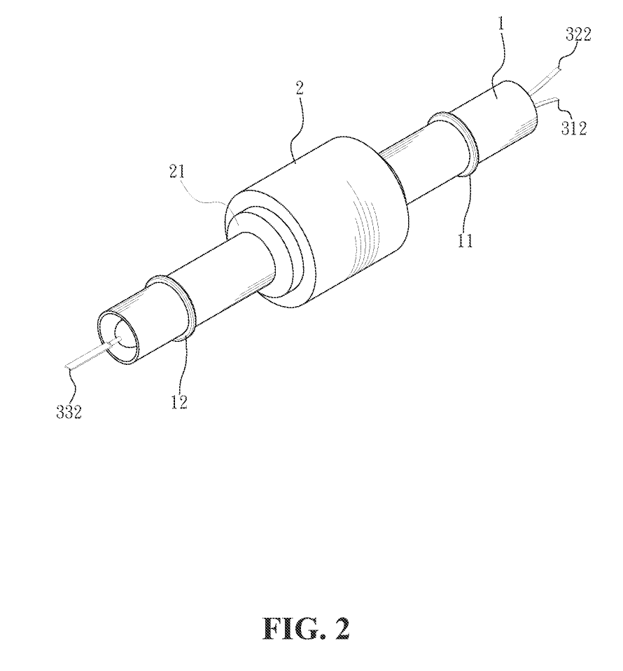

As shown in FIG. 2, the assembly of the float switch device of the present invention is completed by mounting the magnetic switch 3 in the tubular member 1. The mounting position of the magnetic switch 3 should be mounted according to the moving range of the magnet tube 2 between the first and second restriction portion 11 and 12, so that when the magnetic switch 3 abuts against the first restriction portion 11, the tubular magnet 21 is at the contacting position so as to magnetically attract the interior contact point 331 of switching metal tongue 33 and the interior contact point 321 of second metal tongue 32. On the other hand, when the magnetic switch 3 abuts against the second restriction portion 12, the switching metal tongue 33 is no longer attracted to the tubular magnet 21, therefore the interior contact point 331 of the switching metal tongue 33 restores back to its initial position (in contact with the interior contact point 311 of first metal tongue 31) due to its flexibility.

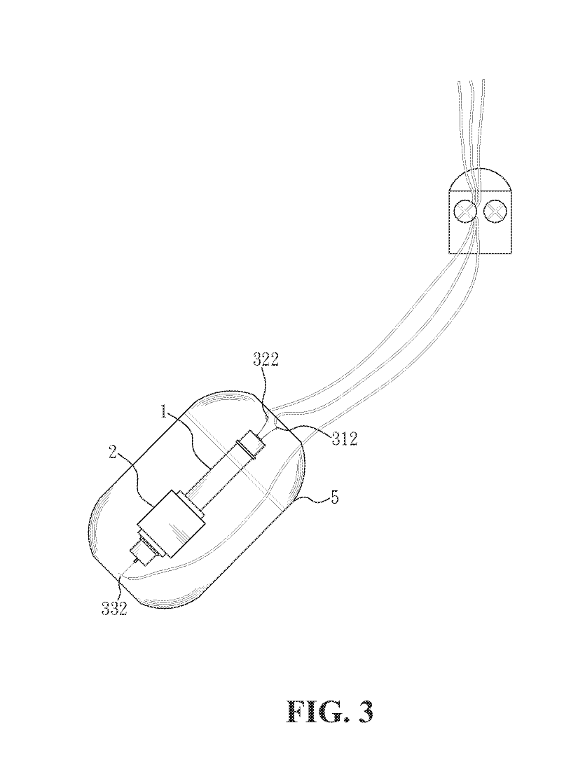

As shown in FIG. 3, the assembly of the tubular member 1, the magnet tube 2 and the magnetic switch 3 is placed inside an outer casing 5, which is connected to a fixed point via a cable for serving as the float switch device of the present invention. The casing has a hallowed body so as to float the float switch device on the liquid.

With different configurations between the external apparatus and the exterior contact points 312, 322 and 332 of the metal tongues, the present invention is applied in different conditions. Herein, two embodiments with two different configurations will be described.

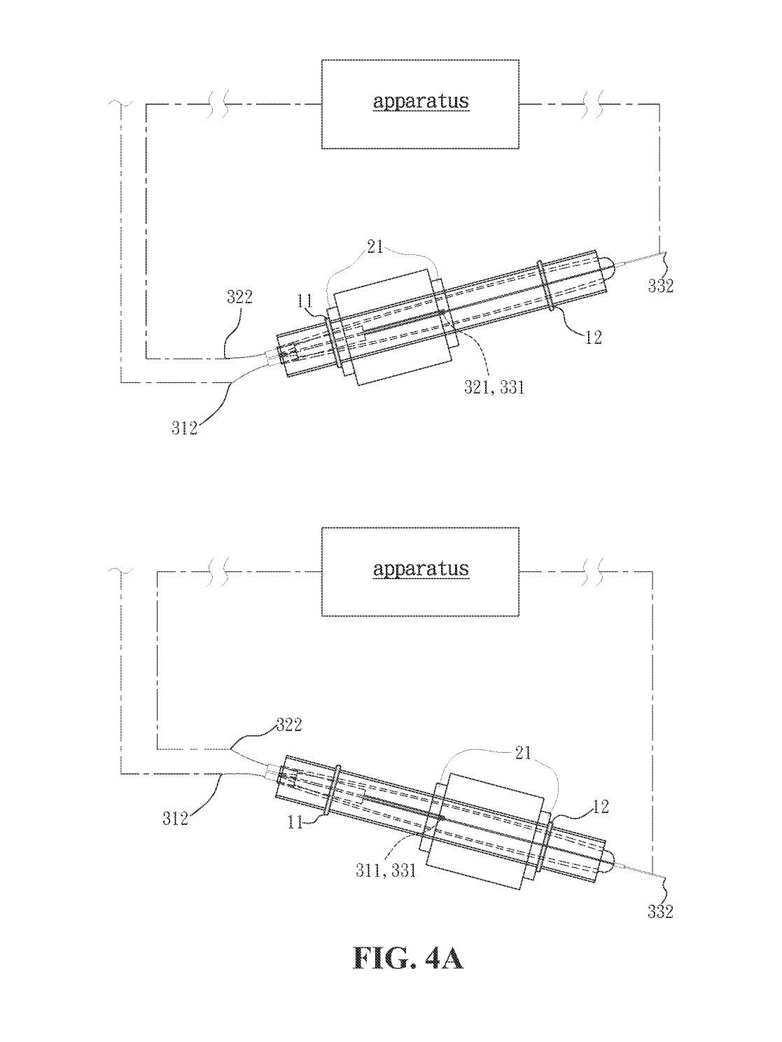

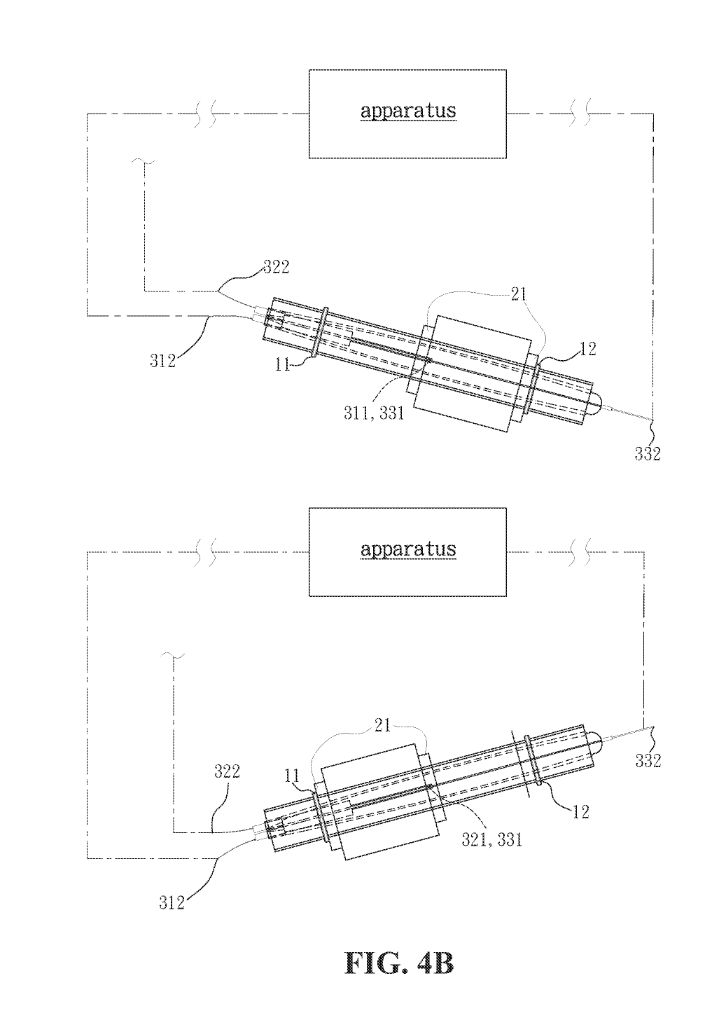

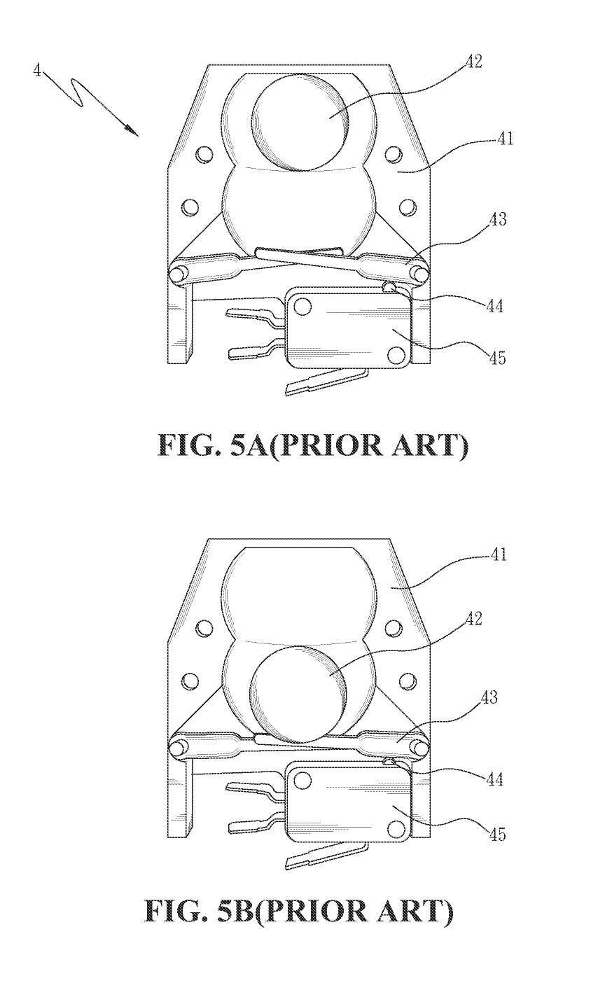

FIG. 4A is the schematic view showing the first embodiment of the present invention in use. In FIG. 4A, the exterior contact point 322 of the second metal tongue 32 is electrically connected with the exterior contact point 332 of the switching metal tongue 33. In the first embodiment, two cables of the external apparatus are connected to the exterior contact points 322 and 332 respectively.

As shown in FIG. 4A, when the float switch device is not yet floated, the magnet tube 2 abuts against the second restriction portion 12, where the interior contact point 331 of switching metal tongue 33 is not attracted. Under this condition, the second metal tongue 32 is not electrically connected with the switching metal tongue 33. Once the float switch device of the present invention is in the floated state, the magnet tube 2 slides toward the first restriction portion 11 due to gravity, and hence attracts the interior contact point 331 of the switching metal tongue 33 to be in contact with the interior contact point 321 of the second metal tongue 32 via the tubular magnet 21. In this way, the float switch device of the present invention establishes an electrical communication or forms a looped circuit between the external apparatus and the float switch device of the present invention. In other words, the float switch device of the present invention is switched “ON”.

FIG. 4B is the schematic view showing the second embodiment of the present invention in use. In FIG. 4B, the exterior contact point 312 of the first metal tongue 31 is electrically connected with the exterior contact point 332 of the switching metal tongue 33. In the second embodiment, two cables of the external apparatus are connected to the second contact points 312 and 332 respectively.

As shown in FIG. 4B, when the float switch device of the present invention is in the floated state, the magnet tube 2 abuts against the second restriction portion 12, where the interior contact point 331 of switching metal tongue 33 is attracted and in contact with interior contact point 321 of second metal tongue 32. Under this condition, the first metal tongue 31 is not electrically connected with the switching metal tongue 33. Once the float switch device is not in the floated condition, the magnet tube 2 slides toward the second restriction portion 12 due to gravity, so that the interior contact point 331 of the switching metal tongue 33 is not attracted and is in contact with the interior contact point 311 of the first metal tongue 31. In this way, the float switch device of the present invention establishes an electrical communication or forms a looped circuit between the external apparatus and the float switch device of the present invention. In other words, the float switch device of the present invention is switched “ON”.

From the above description, it is clearly seen that the application range of the float switch device of the present invention is broader than the conventional float switch device.

The float switch device according to the first embodiment as shown in FIG. 4A can be utilized in a sewage storage tank by placing the float switch device in the tank in the configuration as shown in FIG. 3. In the first embodiment, the exterior contact points 322 and 332 are connected to the external apparatus, which can be a pumping motor in this case. When the casing 5 is floated due to a high water level in the sewage storage tank, the magnet tube 2 abuts the first restriction portion 11. At this position, the interior contact point 331 of the switching metal tongue 33 is attracted by the tubular magnets 21 to be in contact with the interior contact point 321 of the second metal tongue 32, thereby activating the pumping motor to drain the water out of the sewage storage tank. After a certain time when the water level lowers, the magnet tube 2 slides back to abut against the second restriction portion 12, thereby returning the interior contact point 331 of switching metal tongue 33 back to its initial position to be in contact with the interior contact point 311 of the first metal tongue 31. In this way, the pumping motor is turned “OFF” to save energy.

On the other hand, the float switch device according to the second embodiment as shown in FIG. 4B can be utilized in a water storage tank by placing the float switch device in the tank in the configuration as shown in FIG. 3. In the second embodiment, the exterior contact points 312 and 332 are connected to the external apparatus, which can be a pumping motor in this case. When the water level in the water storage tank is low, the magnet tube 2 abuts the second restriction portion, and the interior contact point 311 of first metal tongue 31 is electrically connected with the interior contact point 331 of switching metal tongue 33, thereby activating the motor to replenish the water tank. After a certain time when the water level rises, the magnet tube 2 slides back to abut against the first restriction portion 11, thereby attracting and switching the interior contact point 331 of switching metal tongue 33 to be in contact with the interior contact point 321 of the second metal tongue 32. In this way, the pumping motor is turned “OFF” to save energy.

Noteworthy, the first and second restriction portions 11 and 12 are made from magnetic materials, so the tubular magnets 21 on the magnet tube 2 are attracted and thus fixed to the restriction portions 11 and 12 at both “ON” and “OFF” positions. In this way, the positioning of the magnet tube 2 can be more precise, thereby solving the problem of conventional float switch device, in which the conventional float switch device is harder to be turned “ON” or “OFF” precisely due to the high degree of freedom of the ball 42.

The first and second embodiments described above are for illustrative purpose as where the present invention can be utilized. The locations of application are not to be limited by the embodiments, as the present invention can be applied to any occasion where the liquid level varies. In addition, the relation between “ON” and “OFF” of the float switch device and the water level can be determined by the configuration of the cable as shown in FIG. 3. Furthermore, the number of the float switch device according to the present invention utilized can be plural, so the external apparatuses connected can be turned “ON” or “OFF” at more than one water level.

The preferred embodiments described above are disclosed for illustrative purpose but to limit the modifications and variations of the present invention. Thus, any modifications and variations made without departing from the spirit and scope of the invention should still be covered by the scope of this invention as disclosed in the accompanying claims.

What is claimed is:

1. A float switch device comprising:
a tubular member including a first restriction portion and a second restriction portion formed on an external surface thereof;
a magnet tube sleeved slidably over said tubular member so as to be movable between said first restriction portion and said second restriction portion; and
a magnetic switch including at least two metal tongues, and each of said metal tongue including an interior contact point and an exterior contact point;
wherein, said magnetic switch is inserted into said tubular member in such manner that said interior contact point is attracted by said magnet tube while said exterior contact point is exposed from said tubular member.

2. The float switch device as claimed in claim 1, further comprising a casing for enclosing an assembly of said tubular member, said magnet tube and said magnetic switch with said exterior contact point connected electrically to an external apparatus.

3. The float switch device as claimed in claim 2, wherein said metal tongues include a first metal tongue a second metal tongue and a switching metal tongue, each of said first, second and switching metal tongues having two opposite ends respectively defining said interior contact point and said exterior contact point, wherein, said interior contact point of said first metal tongue is electrically in contact with said interior contact point of said switching metal tongue such that when said magnet tube abuts against said first restriction portion of said tubular member, said interior contact point of said switching metal tongue is attracted by said magnet tube to be electrically in contact with said interior contact point of said second metal tongue.

4. The float switch device as claimed in claim 3, wherein the external apparatus is electrically connected to said exterior contact point of said switching metal tongue and said exterior point of said first metal tongue.

5. The float switch device as claimed in claim 3, wherein the external apparatus is electrically connected to said exterior contact point of said switching metal tongue and said exterior point of said second metal tongue.

6. The float switch device as claimed in claim 1, wherein said first restriction portion and said second restriction portion are made from magnetic materials.

7. The float switch device as claimed in claim 2, wherein said first restriction portion and said second restriction portion are made from magnetic materials.

8. The float switch device as claimed in claim 3, wherein said first restriction portion and said second restriction portion are made from magnetic materials.

9. The float switch device as claimed in claim 4, wherein said first restriction portion and said second restriction portion are made from magnetic materials.

10. The float switch device as claimed in claim 5, wherein said first restriction portion and said second restriction portion are made from magnetic materials.
